(19) United States
(12) Patent Application Publication
(10) Pub. No.: US 2006/0102555 A1
(43) Pub. Date: May 18, 2006

(54) Filter connector

(76) Inventors: Lowell Stephen Jordan, Murrieta, CA (US); James Lowell Jordan, Murrieta, CA (US)

Correspondence Address: Lowell Stephen Jordan, 19823 Avenida Rosella, Murrieta, CA, 92562, US

(21) Appl. No.: 10/989,860

(22) Filed: Nov. 15, 2004

(51) Int. Cl. B01D 39/00

(52) U.S. Cl. 210/500.1; 210/541; 210/542; 210/232

(57) ABSTRACT

This invention relates to a filter connector consisting of (1) an end which can be inserted into, and attached, to a Luer Lok, (2) a Leur Lok at the other end, and (3) a filter housed between them. The connector can be used with any size needle or cannula used with syringes so that the needle or cannula would serve as a filter needle or a filter for blunt cannulas used with needleless systems. The connector can be used for aspirating or injecting fluids, emulsions, or mixtures.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to a filter connector consisting of (1) an end which can be inserted into, and attached, to a Luer Lok, (2) a Leur Lok at the other end, and (3) a filter housed between them. The connector can be used with any size needle or cannula used with syringes so that the needle or cannula would serve as a filter needle or a filter for blunt cannulas used with needleless systems. The connector can be used for aspirating or injecting fluids, emulsions, or mixtures.

### BACKGROUND OF THE INVENTION

Filters are used to remove unwanted particulate matter from fluids, especially when they would be harmful to the system or organism into which the fluid is introduced. For example, pipette tips may be furnished with filters to reduce particulate transfer (U.S. Pat. Nos. 4,267,729, 5,496,523, 6,117,394, 6,482,362). Filters are also used inline, particularly with IV and/or blood transfusions. Another notable use of a filter, when transferring fluids, it to reduce the number of glass particles which contaminate aspirate from a glass ampule. The use of a 19-gauge, 1,5 inch needle with a 5 micron filter has been shown to reduce the number of glass particles extracted from a 10 mL glass ampule from about 100 to 0 (or 1). The consequent reduction in glass particles, which would otherwise be introduced into a patient's blood or CSF, reduces inflammatory reactions (e.g., phlebitis) and granuloma formation (in lung, liver, kidney, and intestinal tissues). However, desirable as a filter needle may be, physicians (and other healthcare professionals) may aspirate fluid directly from opened ampules. They may then inject the fluid, without any removal of glass particles therein, directly into a bloodstream, dermis, or spinal column. Filter needles are not packaged in kits (e.g., for epidurals) and, even then, they might be scarce or absent in a particular hospital floor or clinic. Thus, patients are being directly harmed through the injection of sharp glass particles into their bodies.

Simply increasing the number and availability of filter needles would not solve all the problems. The use of a filter needle is also limited for injection purposes since it comes in one size (19-gauge, 1,5 inch needle with a 5 micron filter). However, needles range from 18 to 28 gauge and from 0.75 to 3 inch length. The selection of a needle depends upon what kind of injection is being done (e.g., intramuscular, intradermal, subcutaneous), characteristics of the patient (e.g., weight, muscle development), site selected (e.g., deltoid, gluteus, vastus lateralis), and fluid being injected. Also, the use of a stainless steel filter needle would be contraindicated with needleless systems (for which a blunt plastic cannula may be used.).

A problem with making the different needles and cannulas with filters, besides the one already produced, would be costly and burdensome in terms of inventory. What is needed is a replacement for the current filter needle, so that fluids can be filtered and kept sterile, while allowing the use of commonly available needles and cannulas. The current invention serves that purpose. It allows for sterile filtering of contents. It permits the use of currently available syringes, needles and cannulas. It facilitates patient safety and welfare while reducing costs doing so.

### PRIOR ART REFERENCES TO INVENTION (AS PER IDS/PTO-1449)

None.

### U.S. Patent Documents Cited in Background of Invention

| Document | | | | |
|---|---|---|---|---|
| Number | Date | Name | Class | Subclass |
| 4,267,729 | May 19, 1981 | Eddleman & | 72/425 | 422 |
| | | Morgan | | |
| 5,496,523 | Mar 5, 1996 | Gazit & | 422/100 | 73 |
| | | Yamiv | | |
| 6,117,394 | Sept 12, 2000 | Smith | 422/100 | 73, 422, 436 |
| 6,482,362 | Nov 19. 2002 | Smith | 422/100 | 73, 422, 436 |

### OBJECTS AND ADVANTAGES

Accordingly, several objects and advantages of the present Patent Application of Lowell S. Jordan and James L. Jordan for the “Filter connection” invention are:

(a) to permit sterile filtration of fluids into or out of a syringe with currently available needles and cannulas;

(b) to permit the filtration of fluids with different porosities of filters;

(c) to permit the use of a filtered system with needleless systems;

(d) to permit the filtering in which the filter unit is firmly secured between attached parts (such as syringe and needle);

(e) to reduce the number of harmful materials/ particles that may be injected into patients.

### BRIEF SUMMARY OF THE INVENTION

In accordance with the present invention, a filter connector has been developed consisting of (1) an end which can be inserted into and attached to a Luer Lok, (2) a Leur Lok at the other end, and (3) a filter housed between them. The connector can be used with any size needle or cannula used with syringes so that the needle or cannula would serve as a filter needle or a filter for blunt cannulas used with needleless systems. The connector can be used for aspirating or injecting fluids, emulsions, or mixtures. The filter itself can be of different porosities, including the 5 micron filter that is used with filter needles.

### DRAWINGS—FIGURES

The above, and other embodiments of the present invention, may be more fully understood from the detailed description taken together with the accompanying drawings illustrating examples wherein similar references characters refer to similar elements in which:

FIG. 1 illustrates a filter connector in cross section which has a flange to permit joining to a Luer Lok;

FIG. 2 illustrates a filter connector top in cross section which has threads to permit joining to a Luer Lok;

FIG. 3 illustrates a filter connector top in external view which has threads to permit joining to a Leur Lok;

FIG. 4 illustrates which is the same diameter as the input lumen and output lumen;

FIG. 6 illustrates a filter which has a filter which at its top end has the same diameter as the input lumen but tapers so that its bottom has the same diameter as the output lumen;

FIG. 7 illustrates a filter which has a filter which at its top end has the same diameter as the input lumen but is curved so that its bottom has the same diameter as the output lumen;

### REFERENCES NUMERALS

1 Upper portion attachable to a Leur Lok

2 Flange

3 Input lumen

4 Middle portion containing the filter

5 Unit housing

6 Filter

7 Nipple

8 Lower portion with Leur Lok

9 Threads of the Leur Lok

10 Output lumen

11 Threads of upper portion

### DESCRIPTION OF THE PREFERRED EMBODIMENTS

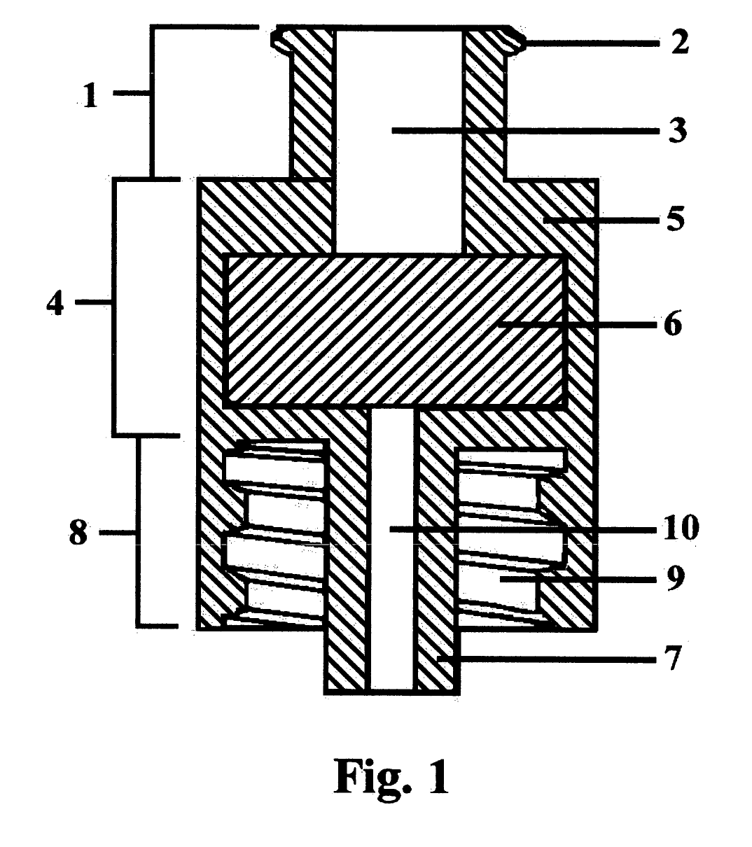

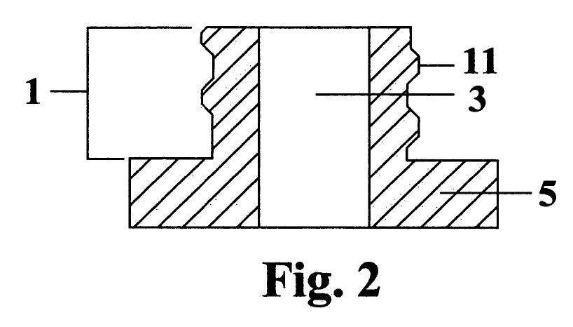

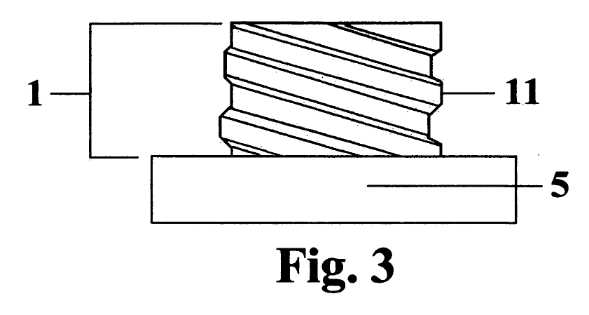

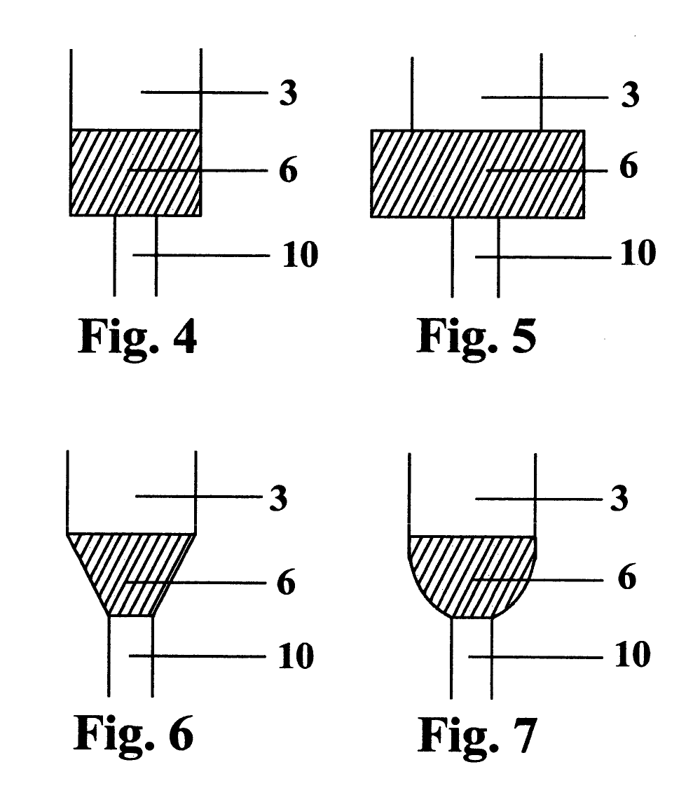

Referring now to the Drawings, there is shown in FIG. 1 a filter connector consisting of three regions formed from the (5) unit housing: an (1) upper portion attachable to a Leur Lok, a (4) middle portion containing the filter, and a (8) lower portion with the Leur Lok. The (1) upper portion attachable to a Luer Lok contains the (2) flange to secure to a Leur Lok and the (3) input lumen (which may serve to receive a tip as for syringes). The (4) middle portion containing the filter of the filter connector contains the (6) filter which is situated between the (3) input lumen and (10) output lumen. The (8) lower portion with Leur Lok contains the (7) nipple (which can attach to the tip of a syringe), (9) threads of the Luer Lok for securing onto a device designed for securing to a Leur Lok (e.g., hub portion of a needle), and the (10) output lumen. FIG. 2 represents the cross section of an (1) upper portion attachable to a Luer Lok which contains (11) threads of upper portion which can be connected to a Luer Lok. FIG. 3 represents the external view of an (1) upper portion which contains (11) threads of upper portion attachable to a Leur Lok. FIG. 4 represents a (6) filter which is the same diameter as the (3) input lumen and (10) output lumen. FIG. 5 illustates a (6) filter which has a larger diameter than the (3) input lumen and (10) output lumen. FIG. 6 illustrates a (6) filter which is at its top has the same diameter as the (3) input lumen but tapers so that its bottom has the same diameter as the (6) output lumen. FIG. 7 illustrates a (6) filter which at its top end has the same diameter as the (3) input lumen but is curved so that its bottom has the same diameter as the (6) output lumen.

The (5) unit housing, which forms the foundation for the (1) upper portion attachable to a Luer Lok, (4) middle portion containing the filter, (8) lower portion with Luer Lok, can be constructed from an impermeable monomeric, bimeric, or polymeric material. It can be made from a number of materials including latex rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methylacrylate plastic, polyacrylonitrile plastic, vinyllite plastic, saran plastic, polytetraflouromethylene plastic, polytriflourochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose plastic, wool fiber, animal skin, animal intestinal tissue, animal connective tissue, metallic fiber, mineral fiber, any manmade material, any plant material, any animal material, and mixtures thereof.

The (6) filter, contained in the (4) middle portion containing the filter is a porous component,—being made of from a number of materials including latex rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methylacrylate plastic, polyacrylonitrile plastic, vinyllite plastic, saran plastic, polytetraflouromethylene plastic, polytriflourochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose plastic, wool fiber, animal skin, animal intestinal tissue, animal connective tissue, metallic fiber, mineral fiber, any manmade material, any plant material, any animal material, and mixtures thereof.

The filter connector can be made to size according to the application to which it is applied. If it is used with syringes, the (3) input lumen could be made to allow insertion of the tip of the syringe into it while the (2) flange or (11) threads of the upper portion can secure the filter unit onto a Leur Lok (if the syringe is so constructed). If the syringe does not have a Luer Lok, then the filter connector can be secured to the syringe by the insertion of the syringe tip into the (3) input lumen. The Luer Lok end of the filter connector would serve to attach a needle, a cannula, tubing, or anything designed to attach to a Leur Lok.

Having described our invention, we claim:

1: A filter connector comprising of:
(a): upper portion attachable to a Luer Lok
(b): middle portion containing the filter
(c): lower portion with Leur Lok.

2: The upper portion attachable to a Leur Lok, as per claim 1(a), is attachable using flange or thread.

3: housing of the filter connector being constructed from any of the following impermeable monomeric, bimeric, or polymeric materials, in this invention, as per claim 1: latex rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methylacrylate plastic, polyacrylonitrile plastic, vinyllite plastic, saran plastic, polytetraflouromethylene plastic, polytriflourochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose plastic, wool fiber, animal skin, animal intestal tissue, animal connective tissue, metallic fiber, mineral fiber, any manmade material, any plant material, any animal material, and mixtures thereof.

4: the filter of the filter connector being constructed from any of the following materials—monomeric, bimeric, or polymeric—in this invention, as per claim 1: latex rubber and mixtures thereof, cellulose acetate plastic, vinyl plastic, polyethylene plastic, polypropylene plastic, polyvinyl chloride plastic, polyvinyl acetate plastic, polystyrene plastic, polymethyl methylacrylate plastic, polyacrylonitrile plastic, vinyllite plastic, saran plastic, polytetraflouromethylene plastic, polytriflourochloroethylene plastic, polycaprolactam plastic, polyester plastic, urea formaldehyde plastic, polyurethane plastic, isotactic polypylene plastic, nylon plastic, rayon plastic, polyamide plastic, phenolic plastic, silicone plastic, silk fiber, cotton fiber, cellulose plastic, wool fiber, animal skin, animal intestinal tissue, animal connective tissue, metallic fiber, mineral fiber, any manmade material, any plant material, any animal material, and mixtures thereof.
